(19) United States
(12) Patent Application Publication
(10) Pub. No.: US 2023/0286846 A1
(43) Pub. Date: Sep. 14, 2023

(54) MICROPLASTIC SEPARATOR

(71) Applicant: INHERITING EARTH LIMITED, Bristol (GB)

(72) Inventors: Adam ROOT, Bristol (GB); Reuben KETTLE AIERS, Bristol (GB); Thomas RUDDELL, Bristol (GB)

(21) Appl. No.: 17/754,649

(22) PCT Filed: Oct. 8, 2020
(86) PCT No.: PCT/IB2020/059454

§ 371 Date: Apr. 7, 2022

(30) Foreign Application Priority Data
Aug. 10, 2019 (GB) 1914545.7

(51) Int. Cl. C02F 9/00; D06F 39/08; D06F 39/10; D06F 34/20; B04C 3/06; B04C 9/00; B01D 29/90; B01D 29/11; B01D 29/58; B01D 29/60; B01D 35/143; B01D 35/147; B01D 29/64; B01D 36/04

(52) U.S. Cl. CPC C02F 9/00; B01D 29/114; B01D 29/58; B01D 29/606; B01D 29/6438; B01D 29/902; B01D 29/908; B01D 35/1435; B01D 35/147; B01D 36/045; B04C 3/06; B04C 9/00; D06F 34/20; D06F 39/083; D06F 39/10; D06F 2103/42

(57) ABSTRACT

The invention relates to preventing microplastics from the entering the environment. In particular the invention is directed to filtering microfibers from the waste water from washing machines as well as waste from other appliances and other sources of effluent with entrained microplastics or other microp-ollutants. A separator is provided for separating microplastics from effluent comprising; a chamber including at least one sieve structure, a shroud that acts as a vortex finder and a baffle coaxial with the shroud and projecting upwards from the lower end of the chamber, wherein the shroud has a circular lower rim and the baffle has a circular upper rim, wherein the radius of the lower rim of the shroud is greater than the radius of the upper rim of the baffle.

### BACKGROUND

### Field of the Invention

The invention relates to preventing microplastics from entering the environment. The invention is directed to filtering microplastics from any effluent. It is particularly suited to filtering microfibers from the wastewater of domestic washing machines and other appliances. It is also suited to filtering microfibers from the effluent from commercial scale washing machines and textile manufacturing processes. It is also suited to filtering microplastics and micropollutants from other effluent such as the runoff from roadside gullies.

### Description of Related Art

Microfibres are the most abundant form of microplastic pollution in rivers and oceans. Due to their microscopic scale, microfibers are eaten by organisms at all levels of the food chain, from plankton to top predators. Once ingested, plastics reduce feeding efficiency (false satiation) they may damage the gut of the animal and transfer harmful additives like PCBs, pesticides, flame retardants to the animal that consumed it. Plastics consumed by animals low in the food chain also impact their predators, which consume numerous contaminated prey daily. The pervasiveness of microfibers in the food chain has naturally resulted in concern regarding their transfer to humans, and contamination has been observed in crustaceans, molluscs and fish species destined for human consumption.

Unlike microbeads, which are easily excluded from toiletries and cleaning products, microfibres are formed through damage to clothing. One third of all microplastics in the oceans come from washing of synthetic textiles. Synthetic fabrics derived from petrochemicals make up 65% of all textiles. Wear and tear caused by abrasive forces in washing machines and textile manufacture processes result in the fragmentation of man-made textiles, forming hundreds of thousands of microfibres, less than 5 mm in length, which leak from homes and drainage networks into the ocean.

Wastewater treatment plants cannot remove the millions of fibres that pass through them every day. Currently, secondary level water treatment removes around 98% of the microplastics that pass through them. However, the small proportion that escapes still equates to tens of millions of fibres per treatment works per day.

Furthermore, wastewater treatment plants produce a “sewage sludge” and plastic microfibers are found on discharge when released into the natural environment when the sludge is spread on agricultural land, thus microfibers make their way into the food chain, waste to energy (which can destroy fibres but release harmful gasses) or discharged into rivers or the ocean.

Current washing machine filters are designed to stop pennies and buttons breaking the washing machine pump. The filtration required to stop microfibers is less than 80 micrometers (um), which is about the width of a human hair.

Products that stop the problem at source include Cora Ball™, a laundry ball that captures fibres by tumbling inside the machine. Guppy Friend™ is a mesh bag designed for selected items that tumbles inside the washing machine. The bag is also made of plastic and will degrade over time. There are also pond pump filters or septic tank filters that could be repurposed to stop microfiber plastic. They work on a cartridge-based system which are unrecyclable creating more plastic waste than is captured.

The present invention seeks to provide an effective filter for removing microfibers directly from the effluent of both commercial and domestic washing machines and other appliances and also industrial textile manufacturing facilities. It is not limited to this application and could be used to remove microplastics and other micropollutants from other sources of contaminated effluent such as the runoff from roadside gullies.

### SUMMARY OF THE INVENTION

An embodiment of the invention comprises a separator for separating microplastics from effluent comprising; a chamber having an inlet conduit and an outlet conduit wherein an internal portion of the chamber is circular in cross-section and wherein the inlet conduit is connected tangentially to the circular portion of the chamber, the chamber further including a vortex finder comprising a shroud having a circular cross-section portion extending down into the chamber, the separator further including at least one sieve structure downstream from the shroud and arranged to provide a permeable barrier between the inlet conduit and the outlet conduit, wherein the chamber further includes a baffle that is coaxial with the shroud and projecting upwards from the lower end of the chamber, wherein the shroud has a circular lower rim and the baffle a circular upper rim, wherein the radius of the lower rim of the shroud is greater than the radius of the upper rim of the baffle.

The separator may include a first sieve structure and a second sieve structure downstream from the first sieve structure, wherein the second sieve has a smaller opening size than the first sieve structure.

The outlet may be at the lower end of the chamber. The shroud, the first sieve structure and the second sieve structure may be cylindrical and coaxially aligned.

The outlet may be at the upper end of the chamber. The shroud may be frustoconical. The first sieve structure and the second sieve structure may be conical and coaxial with the shroud.

The sieve structures may comprise a mesh, wherein the mesh size of the first sieve structure may be in the range 20 um to 1 cm, preferably 200-500 um. The mesh size of the second sieve structure may be in the range 20 to 200 um, preferably in the range 40-90 um.

The chamber may have an upper turbulent region and a lower static region separated by at least one baffle. A pair of opposing offset ring baffles may separate the turbulent region from the static region. Fins may be provided in the static region for slowing the radial flow of waste water.

A first sump may be provided below the first sieve structure in the static region and a second sump may be provided below the second sieve in the static region, wherein the first and second sumps are isolated from each other by the first sieve structure.

A removable lid and plug assembly may be provided for emptying the sumps. The end of the separator may be removable for emptying the sumps.

A sensor for detecting fluid pressure at the inlet may be provided. The sensor may be arranged to communicate with a warning system, such that, in use, if the fluid pressure measured by the sensor rises above a first threshold, a warning signal is issued that the separator needs maintenance.

The separator may further include a bypass duct between the inlet and the outlet, wherein the bypass duct is engaged by operation of a bypass valve. The sensor may be arranged to operate the bypass valve if, in use, the fluid pressure measured by the sensor rises above a second threshold, indicating that there is a blockage in the chamber of the separator.

The separator may further include a wash apparatus for washing the sieve structure. The wash apparatus may include at least one channel terminating in the cavity for guiding wash fluid to spray the exterior of the mesh structure. The separator may include a wash fluid valve for controlling the flow of wash fluid into the inlet.

The sensor may be arranged to detect when the flow of effluent has ceased and send a signal capable of opening the wash fluid valve. A water purification element may be included to further filter the wastewater. The water purification element may include activated charcoal within the second mesh structure. The second mesh structure may include a coaxial wall within the second mesh structure and the cavity between these two structures may be filled with activated carbon. A secondary pump may be included to provide enough pressure to the wastewater to urge it through the water purification element.

In an embodiment, a processing appliance is provided including a separator of the type described above. The appliance may be a washing machine or industrial textile manufacturing equipment.

In an embodiment, the separator may be suitable for use in a drainage system. In an embodiment, a drain is provided including the separator described above.

In an embodiment, a method of operating a separator of the type described above is provided, comprising the steps of:
receiving a flow of effluent;
passing the effluent through a cyclonic separation stage;
passing the effluent through a first sieve stage;
passing the effluent through a second sieve stage, where the second sieve pore size is less than the pore size of the first sieve stage;
collecting the debris separated from the effluent by the cyclonic separation and first and second sieve stages.

In the method, the wastewater may be wastewater from a washing machine or from industrial textile manufacturing equipment or from a roadside drain.

### BRIEF DESCRIPTION OF THE DRAWINGS

Embodiments of the invention are described below, by way of example only, by reference to the accompanying drawings, in which:

FIG. 1a is a view of the internal workings of a standard washing machine.

FIG. 1b is a view of an embodiment of the invention installed in the washing machine of FIG. 1a.

FIG. 2a is an isometric view of a first embodiment of the invention.

FIG. 2b is a side-section view of the first embodiment shown in FIG. 2a.

FIG. 2c is a plan view of the first embodiment shown in FIG. 2a.

FIG. 3 is a side-section view of a further embodiment of the invention.

FIG. 4 is a side-section view of a further embodiment of the invention.

FIG. 5a is a side-section view of an embodiment of the invention having a turbulent and a static region.

FIG. 5b is a cross section along the line AA’ in FIG. 5a.

FIG. 5c is a cross section of a plug part.

FIG. 6a is a perspective view of a further embodiment of the invention.

FIG. 6b is a cross sectional view of the embodiment of the invention shown in FIG. 6a.

FIGS. 7a to c show stages of dismantling the embodiment shown in FIGS. 6a and b.

FIG. 7d shows a perspective view of the cap of the separator of FIG. 6a.

FIG. 7e shows a perspective view of the end cup of the separator of FIG. 6a.

FIG. 8a shows the flow of effluent through the embodiment of the separator shown in FIGS. 6a and b.

FIG. 8b shows the removal of the end cup of the embodiment of the separator shown in FIGS. 6a and b.

FIGS. 9a to 9c show a cap of the embodiment of FIG. 6a.

FIG. 10 is a view of an embodiment of the invention installed in a washing machine.

FIG. 11 is a view of the flow path of wash water.

### DETAILED DESCRIPTION OF THE PREFERRED EMBODIMENT

While the description that follows focuses on washing machines for clothes, it is to be understood that the teachings herein are not limited to use in washing machines as they are equally suited to other processing appliances, such as but not limited to driers, such as tumble driers, dyeing machines, cutting machines, recycling machines, dry cleaning machines and so on. The teachings herein could also be used in other industries in which microparticles may be generated as a result of processing of items, for example equipment for use in the industrial manufacture of textiles. References to washing machines herein are therefore to be understood as comprising any similar appliance of the types contemplated herein.

It will further be appreciated that the teachings herein are suited to any application which requires the removal of microplastics, including microfibers, or other micropollutants from any effluent, including wastewater, within which such materials may be entrained. For example, for capturing the solid components entrained in the runoff from roadside gullies, as discussed in more detail below.

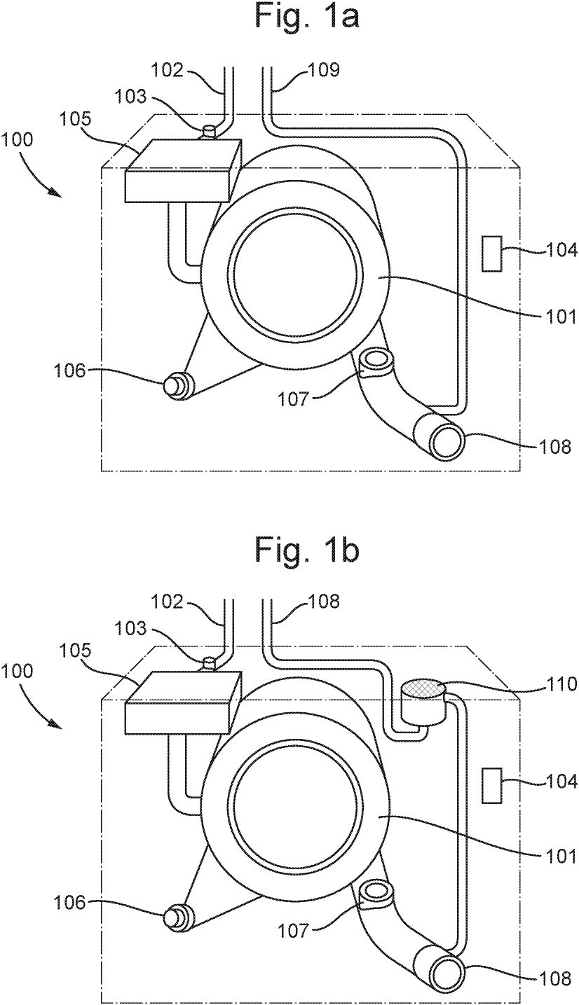

Washing machines are found in domestic and commercial settings. A typical domestic washing machine is shown in FIG. 1a in schematic form. The machine 100 includes a rotatable sealed drum unit 101 for receiving garments to be washed. The sealed drum unit 101 has a perforated cylindrical rotatable drum mounted inside a static waterproof shroud. Clean water is fed into the drum 101 via a cold water inlet 102 connected to mains and under mains pressure of typically 2 bar or above. The water entering the drum 101 is managed by an electronic valve, under the control of a CPU 104. The inlet 102 is connected to a drawer 105 where liquid or powdered detergent can be added by a user. The drawer has an outlet that leads to the drum unit 101. The drum unit may include a heater under the control of the CPU to heat the water to the desired wash temperature, typically up to 90° C. The drum is rotatable by an electric motor 106 under the control of the CPU 104 at speeds of typically from 5 to 1600 rpm. The drum unit can be emptied via an outlet having an electronically operated drain valve 107 and a drain pump 108 both controlled by the CPU. The drain pump is rated with a given power to produce a known pressure at its output. The drain pump feeds into an outlet 109 which is a hose that is placed into a raised pipe that is connected to the household or industrial drain and eventually the wastewater network.

In use, dirty laundry is placed in the drum, and a wash cycle initiated by a user. The CPU allows cold water to flow via the drawer to mix with detergent and then on into the drum, where the water is heated. The combined water, detergent and laundry is agitated by rotating the drum. During this process, dirt and grease are released into the water and fibres from the clothing too. If the clothing is synthetic, microfibers are typically released as the clothes rub against each other, or fibres that have been released through wear are washed out of the garment. The resulting effluent at the end of the wash cycle is a mixture of debris, dirt, grease and microfibers and potentially large objects such as coins or nails left in the clothing. This effluent is then drained and pumped out of the drum at a typical rate of 2 gallons per minute. Second or third rinse cycles with clean water may be performed, resulting in effluent with less concentrated contaminants.

In a typical wash, the highest concentration of microfibers is in the range 5 mm to 150 um but shorter microfibers exist that are still harmful in the environment. If it were required to remove 99% of microfibers of all sizes down to 50 um in length, a mesh with apertures of 50 um would theoretically be able to achieve this. In practice however, such a mesh placed directly in the stream of effluent will clog almost immediately and the filter will become inoperable. This will create a rise in pressure in the outlet and potentially damage the pump and/or cause the washing machine to overflow and flood the home.

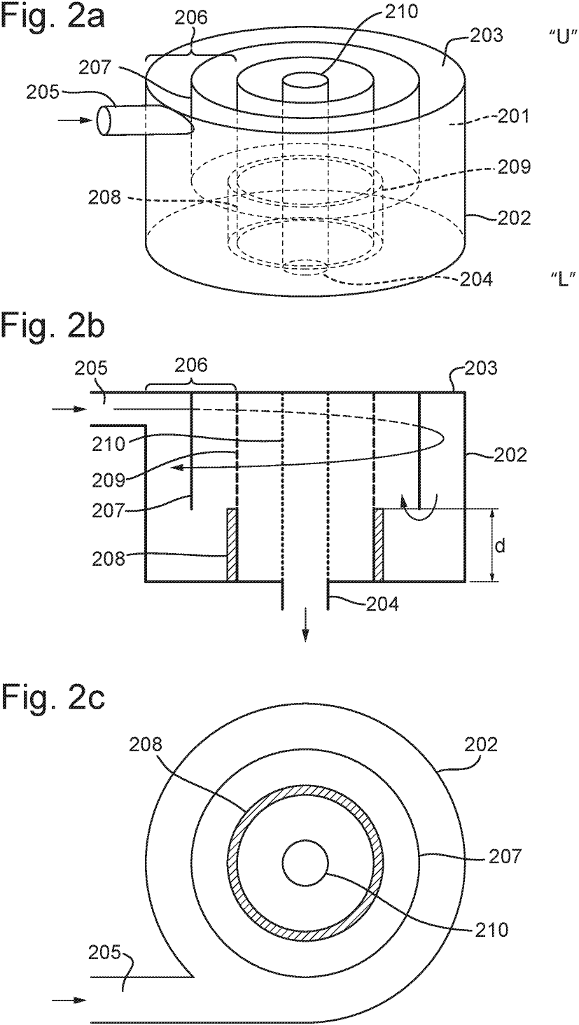

In an embodiment of the invention the problem is solved by providing a three-stage filter assembly for removing progressively finer sized debris, as shown in FIGS. 2a to 2c, thus reducing the load on each stage and increasing the life of the filter and the time between maintenance. The embodiment is capable of removing 99.8% of microfibers of length greater than 25 um. The filter assembly is installed downstream from the pump 108 and before the outlet 109.

A cylindrical vessel 201 has parallel sides 202, a sealed top 203 at an upper end “U” and a sealed bottom at a lower end “L”, with a central outlet 204. The vessel 201 has a tangential inlet 205 at its upper end.

The first stage of the filter assembly is an inertial separator 206 for removing the largest and heaviest particles. The inertial separator 206 is formed of the tangential inlet 205 and the cylindrical inside walls of the vessel 201 which cause the incoming effluent to rotate, throwing larger debris to the outside of the vessel under centrifugal force where the debris sinks to the bottom of the vessel. A further feature of the inertial separator stage is a vortex finder 207 and baffle 208 arrangement. The vortex finder 207 is a cylindrical shroud of a smaller radius than the walls of the vessel. The vortex finder 207 projects down from the top of the vessel to a distance “d” from the bottom of the vessel. The baffle 208 is a cylindrical wall of smaller radius than the vortex finder 207 and projects up from the base of the vessel to a distance “d”. As the effluent makes its way from the inlet 205 to the outlet 204 it turns sharply upwards under the vortex finder and this movement throws further debris out of the flow, which then sinks to the bottom of the vessel.

The second stage of the filter assembly is a cylindrical coarse mesh 209 of approximately 400um opening size, but can be anywhere in the range 20 um to 1 cm. The coarse mesh 209 is of the same radius as the baffle 208 and extends from the top of the baffle to the top of the vessel. Effluent reaching this coarse mesh 209 has a rotational component and matter entrained in the effluent will strike the mesh tangentially, which enhances the filtering effect as long fibrous material gets stuck to the outside of the mesh. This mesh will also tend to agglomerate dispersed particles as they pass through.

The mesh acts as a type of sieve. Any other structure that is capable of sieving material from the flow could be used, such as a perforated sheet or a permeable membrane.

The third stage of the filter assembly is a cylindrical fine mesh 210 running from the top of the vessel 201 to the outlet 204. This mesh has a spacing of 80um but can be anywhere in the range 20 to 200 um. 80 um is selected because this is large enough to let particles of un-dissolved washing powder through but not microfibers of 50 um in length. Microfibers of a greater length than the pore size of the mesh are stopped because the direction of flow of wastewater is across the mesh, and the microfibers are generally orientated with the flow and therefore tangentially to the mesh openings; the pore size that is apparent to the fibers is much less than the actual pore size. The third stage is the final filtration stage before the effluent reaches the outlet and is capable of capturing microfibers of lengths down to 50um.

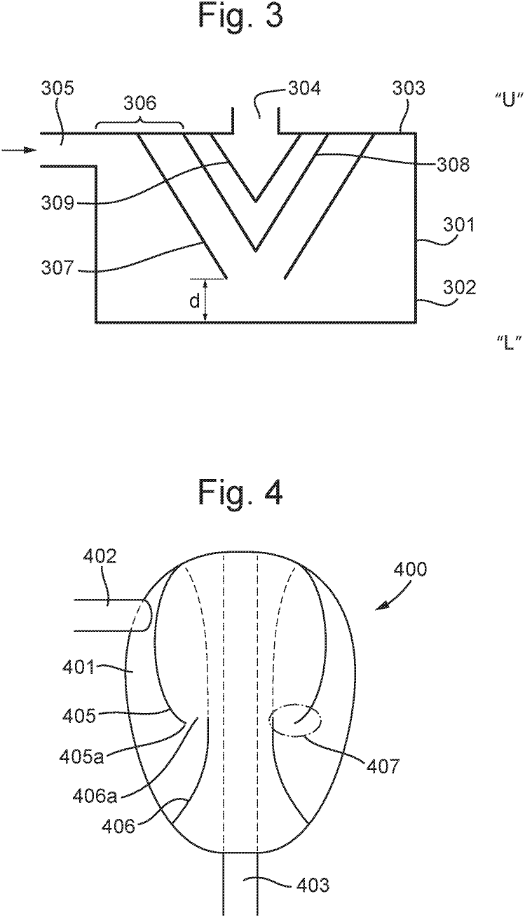

Alternatively, the outlet may be at the top, as shown in FIG. 3. A cylindrical vessel 301 has parallel sides 302, a sealed top 303 at an upper end “U” with a central outlet 304 and a sealed bottom at a lower end “L”. The vessel 301 has a tangential inlet 305 at its upper end.

Similarly to the embodiment shown in FIG. 2, this version also includes an inertial separator stage 306 for removing the largest and heaviest particles. The inertial separator 306 is formed of the tangential inlet 305 and the cylindrical inside walls of the vessel causing the incoming effluent to rotate, throwing larger debris to the outside of the vessel under centrifugal force where the debris sinks to the bottom of the vessel. A frustoconical vortex finder 307 reaches down into the vessel chamber from the top 303 to guide the incoming stream downwards so that as the effluent makes its way from the inlet 305 to the outlet 304 it turns sharply upwards under the vortex finder and this movement throws further debris out of the flow, which can then sink to the bottom of the vessel.

The selection of the distance “d” between the lower edge of the vortex finder and the base of the chamber can be used to tune the separation efficiency of the device. For example, a narrow gap will provide an increased velocity of fluid at this point, which will more effectively separate debris out of the flow. However, this requires a greater pressure consumption (the difference between the pressure at the inlet and pressure at the outlet). Alternatively a wide gap will have a lower pressure consumption, but the fluid velocity will be lower and therefore less debris will be separated at this stage. Tuning the gap is important because pressure is delivered by the washing machine pump, but it is limited and can only deliver a pre-determined amount until it fails, or leakages occur. The present invention therefore seeks to maximise separation efficiency and minimise energy consumption so that the device makes a low pressure demand on the pump. Typical flow rates for washing machines are 10 litres per minute, pumped to a height of 90 cm; enough to get the waste water up and into the raised pipe that feeds into the wastewater network.

Nested conical meshes reside within the vortex finder, comprising a first coarse mesh 308 of approximately 400 um opening size and a fine mesh 309 with a spacing of 80um. It is the final filtration stage before the effluent reaches the outlet and is capable of capturing microfibers of lengths down to 50um.

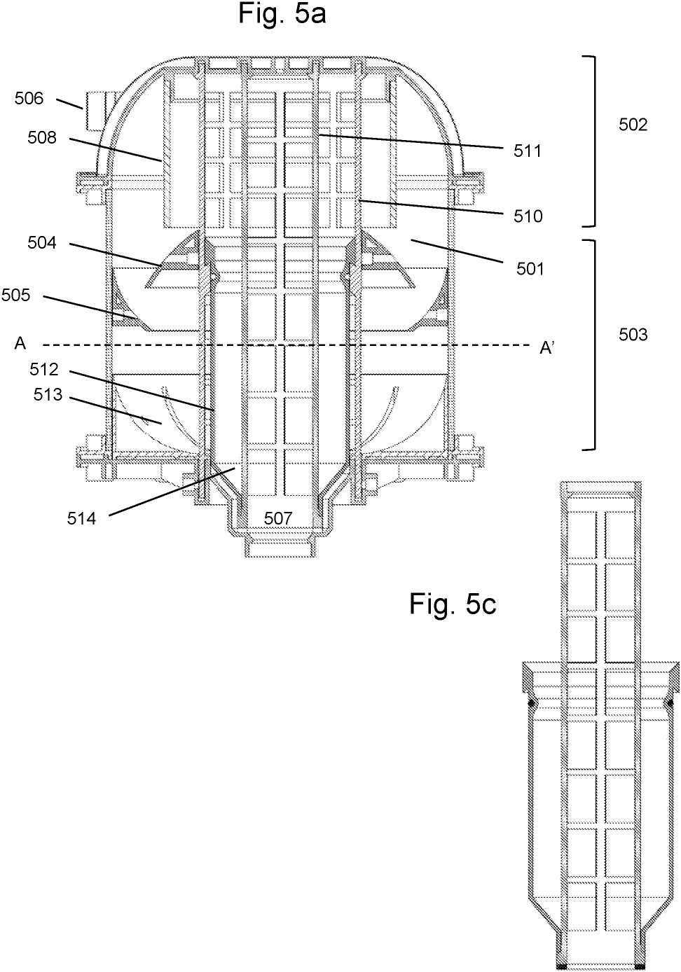

In some embodiments, the separator may be ovoid as shown in FIG. 4. The separator 400 has a chamber 401 wherein an internal portion of the chamber is circular in cross-section. The chamber has a tangential inlet conduit 402 towards its upper end and an outlet conduit 403 at its lower end. In this embodiment, a portion of the internal wall is circular but it does not have a constant radius along its axial length, i.e. it has rotational symmetry but it is not cylindrical as described in the embodiments above. The tangential input and circular interior still create a cyclonic separation effect because the incoming effluent will be swirled around the inside of the vessel and be imparted with a rotational component, developing a centrifugal moment, causing heavier debris entrained in the effluent to be thrown outwards and then sink to the bottom of the vessel.

Chambers and vortex-finders that have a circular profile with varying radii (i.e. non-cylindrical) can be used to create variations in angular velocity of the effluent within the separator. For example, a separator vessel having a circular wall profile with an increasing radius along its length coupled with a coaxial cylindrical vortex finder will have an increasing distance between the vessel wall and vortex finder; this will result in a decreasing angular velocity of the effluent. Conversely, a vessel with cylindrical walls coupled with a vortex finder with a circular cross section with a radius that increases along its length will have a wall separation as the effluent progresses and the effluent will be imparted with an increasing angular velocity. Other non-cylindrical but rotationally symmetric shapes include cones and hyperboloids.

The separator shown in FIG. 4 further includes a truncated spheroidal vortex finder 405 extending from the top part of the chamber 401 and a hyperboloidic baffle 406 extending from the lower part of the chamber 401. The vortex finder 405 has a lower rim 405a of a given radius, while the baffle 406 has an upper rim 406a of lesser radius than the lower rim 405a of the vortex finder 405. The distance from the top of the chamber of both rims 405a, 406a is approximately equal. This creates a restriction that causes the effluent to accelerate rapidly around the lower rim 405a of the vortex finder, which causes further inertial separation of entrained debris from the effluent.

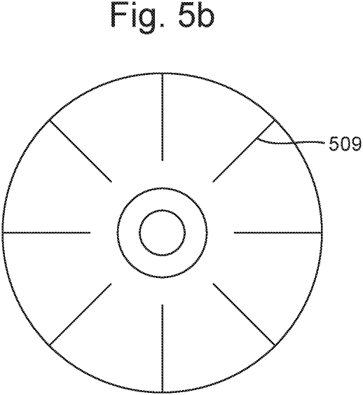

In these embodiments, the solid material falls down to the bottom of the vessel. However, in use, the fluid flowing is turbulent and therefore there is a risk that debris may be re-entrained, i.e. swept back up into the fluid. In a further embodiment and as shown in FIG. 5, is a separator having two sumps for collecting separated debris.

The separator comprises a chamber 501 having two regions; a first turbulent region 502 and a second static region 503. The regions 502, 503 are separated by circular eel trap baffles, in the form of an upper skirt 504, and a lower lip 505 that create a tortuous path between the regions 502, 503. Further baffles may be provided to create an even more tortuous path. As in previous embodiments, the chamber 501 has a circular profile in cross section and has an inlet conduit 506, an outlet conduit 507 and a vortex finder 508 for centrifugally and inertially separating debris from the effluent. The purpose of the baffles is to allow debris that has been inertially separated from the effluent by centrifugal motion around the vessel and by inertial motion as it rounds the end of the vortex finder to drop into the static region 503 and settle at the bottom. The static region also has radial vertical fins 509 projecting into it to stop the circular motion of the effluent in this region and therefore allow a sediment of debris to build up. FIG. 5b shows the arrangement of the fins 509.

The separator 500 also has a coarse cylindrical mesh 510 of mesh size 400um forming a first permeable barrier between the inlet 506 and outlet 507. The mesh size could range from 200-500um, for example. The coarse mesh is arranged to sieve out particles that have not been inertially separated in the first stage. A second structure 511 comprising a coaxial mesh cylinder of mesh size 80 um, but could be a range of sizes for example from 20 to 200 um, provides a final permeable barrier before the outlet 507.

A cylindrical plug 512 defines the inside of the second static region 503 to create a first sump 513 into which debris separated by the centrifugal/inertial separator and the coarse mesh 510 collects. A second sump 514 is defined by the inside of the plug 512 and the fine mesh in which particles filtered by the fine mesh collect. This second sump 514 is where the smallest and therefore the most harmful and difficult to trap microfibers collect. Sumps 513 and 514 are isolated from each other by the fine mesh.

As the effluent is filtered by the three stages and debris gathers in the two sumps, the sumps begin to fill and will eventually clog the separator, reducing its performance. In the embodiment shown in FIG. 5, the top surface of the chamber has a lid that can be removed to expose the mesh structures for cleaning. The plug 512 is a removable cup which can be removed to empty the 50-400 um microfibers that have been collected in the second sump 514.

In operation, the CPU 104 of the washing machine opens the cold water inlet valve 102 to fill the drum 101 with water and detergent and heats the water. After the wash cycle the CPU operates the outlet valve 103 and pump 108. Effluent drained from the drum 101 then enters the separator 500 via inlet 506 under pressure from the pump. The pressure causes the effluent to circulate around the chamber 501, filling the first sump 513 if it is not already filled and then finding a path through the first mesh stage 510. Large particles are thrown out by centrifugal action of the effluent circulating around inside the chamber 501, smaller particles are thrown out by inertial action as the fluid changes direction around the vortex finder 508 and these particles drop down past the eel trap baffles 504, 505 into the first sump 513. Particles of dimension greater than 400 um are captured by the mesh 510, some of which drop down, others stick to the outside of the mesh under the force of the flow of effluent passing through it. The effluent containing particles of dimensions 50-400 um continues to flow and fills the second sump 514 as the filtered water drains through the 50 um mesh 511, a level being reached depending on the flow rate through the mesh. The flow rate through the meshes 510 and 511 depends on the quantity of captured debris clinging to the outside of the meshes. The flow rate will decrease as the meshes become clogged and the level that the effluent reaches up the outside of each mesh will increase for a given flow rate.

When the drum 101 of the washing machine is emptied, the flow of effluent into the separator 500 stops and the fluid effluent drains down to a static level. As the level decreases, some particles clinging to the outside of the meshes 510, 511 will drop down to the sumps 513, 514, but some will remain stuck to the outside of the meshes. The first sump 513 remains full of liquid waste, while the second sump 514 will drain and contain primarily microfibers.

The process is repeated during the next wash cycle, with the sumps becoming more full and the meshes accumulating debris. With each wash cycle the accumulated debris on the meshes and in the sumps will cause the flow rate to decrease to an unacceptable level. This is because the decreased flow rate puts undue pressure on the pump, eventually damaging it. At this stage the separator needs to be emptied to regenerate the pressure consumption.

A pressure sensor (not shown) at the inlet 506 may be provided to detect when the effluent pressure reaches a threshold and a warning given to the user that the separator unit 500 needs to be emptied.

Emptying of the separator unit 500 is performed by removing the lid of the unit and removing the plug 512 to tip out the collected microfibers. Removal of the plug 512 allows the first sump 513 to drain out through the mesh 510. The meshes can then be cleaned and the first sump 513 emptied.

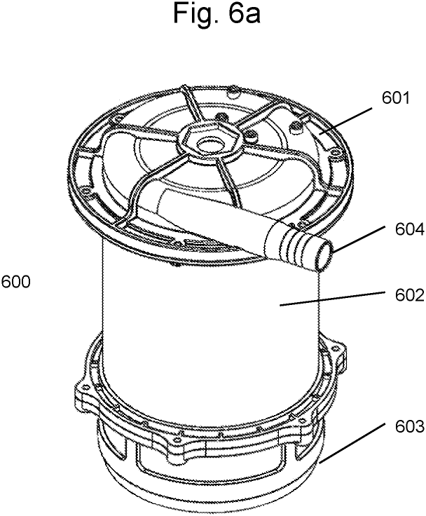

In an alternative embodiment as shown in FIGS. 6a and 6b, the need to invert the unit illustrated in FIGS. 5a and 5b to empty the sumps is addressed, by providing removable sump sections.

The separator unit 600 comprises three major parts; a cap 601, a body section 602 and a lower sump section 603. The cap 601 includes an inlet 604 that feeds into a circular channel that imparts a rotational flow to the incoming effluent. The body 602 includes a toroidal chamber 605 defined by the outer walls of the body 602 and a shroud 606 that acts as a vortex finder. The shroud is fixed to the cap 601. A tubular first mesh support structure 607 of lesser radius than the shroud 606 supports a first cylindrical mesh 608 of pore size 400 um which meets a gasket at the top where it joins the cap 601. The first mesh support structure 607 also supports a skirt 609 which guides the flow of effluent up behind the shroud 606 and also helps to prevent fallen debris returning into the chamber 605.

The shortest distance between the rim of the shroud 606 and the skirt 609 is tuned to suit the required pressure consumption. This tuning is a balance between a relatively narrow gap to create a high fluid velocity so that debris separates from the flow, and a wide gap that does not put too much demand on the pump. A suitable separation distance for a flow rate of 10 litres per minute is 1 cm, but it could be more or less than this depending on the proportions of other elements of the device and the pump specification.

In the region of the skirt 609, the wall of the body 602 supports a deflector ring 610 that forms a lip to guide debris further down into the separator. The skirt and deflector ring form a pair of opposing offset ring baffles to prevent re-entrainment of debris. The first mesh support structure 607 itself has a broad flange 611 that reaches to the wall of the body 602 to which it is attached. The wall, flange and support structure together form a first sump 612 for collecting debris. The skirt 609 and deflector ring 610, i.e. the opposing offset ring baffles, together form an “eel trap” which prevents debris from coming back out of the sump. The first sump includes vertical radial vanes to arrest the circular fluid flow and reduce the amount of sediment being re-entrained in the effluent.

The lower sump comprises an end cup 603 fixed to the bottom of the body 602. Centrally located within the cup is a second mesh support structure 613 that supports a second cylindrical mesh 614 of pore size 50 um that rises to join the cap 601 at a gasket. At the base of the second mesh 614 is a second skirt 615 that can deflect debris into the lower sump 603. At the lower end of the second mesh support structure 613 is an outlet 616.

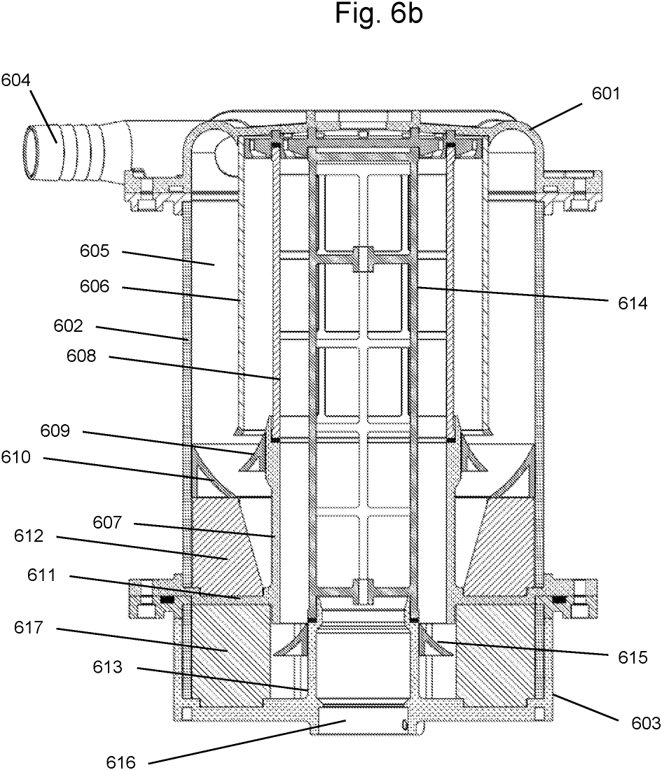

FIGS. 7a to 7c show the stages of assembly of the mesh structures of the separator 600. FIG. 7a shows the body 602 and lower sump 603 preassembled, with the cap 601 removed. The first mesh support structure 607 has a recessed lip 618 for receiving the first mesh 608, and the first mesh is shown in place in FIG. 7b, with a gasket 619 between the two components. The mesh itself is flexible and is therefore mounted on a stiff lattice from 620. In the diagrams, the fine detail of the mesh is not shown, but the lattice frame 620 to which the mesh is bonded is shown. The narrower second mesh 614 mounted on its own stiff lattice 620 is then located onto the second mesh support structure 613 with a gasket between the two components. The cap 601 is then installed seals the unit allowing fluid access only via the inlet 604 and outlet 615. The cap also isolates the internal regions from each other, so that effluent can only pass through the mesh structures on its journey from inlet to outlet.

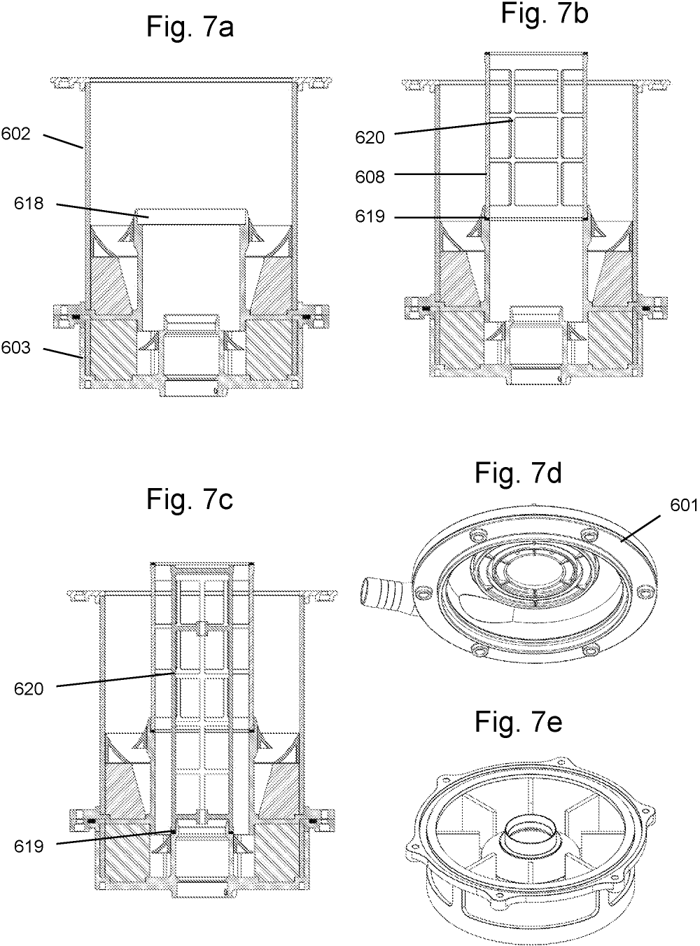

In use, when a wash cycle is complete and the drain pump drains the drum of the washing machine, effluent enters the inlet 604 and then is fed tangentially into the chamber 605, as shown in FIG. 8a. It then rotates within the chamber, throwing larger debris out to the side, which sinks down into the first sump 612. The effluent then turns sharply under the vortex finder 606, ejecting further debris under inertial action as it does so, which sinks into the first sump 612. The effluent then reaches the first mesh 608 which prevents debris and microfibers of size greater than 400 um passing, which either stick to the outside of the mesh or sink down into the first sump 612. The effluent then reaches the second mesh which prevents microfibers of size greater than 50 um from passing. These either adhere to the outside of the mesh or sink down to second sump 617. When the drum is drained, no more effluent flows into the separator and the liquid level inside the chamber 605 drops, so that only the sumps remain with liquid in them. As the liquid level falls, a certain amount of debris will fall off the meshes and into the sumps. The process is repeated for subsequent wash cycles.

The cyclonic separation stage can separate particles of size between 400 um and 20 mm at an efficiency of 60-80%. The first mesh stage removes particles of size down to 400 um at an efficiency of 90-80%. The second mesh stage removes particles down to 50 um at an efficiency of greater than 90%.

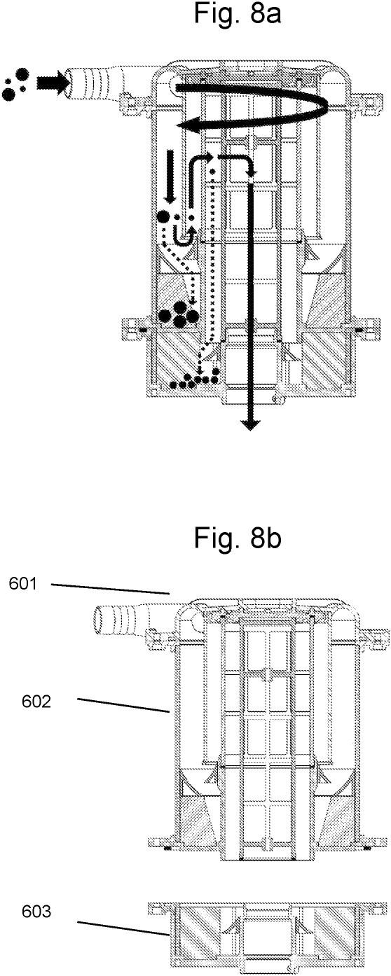

In this embodiment, the cap 601 includes a mesh wash washing arrangement. This is shown in more detail in FIGS. 9a to 9c. The cap 601 has a wash channel insert 801 that comprises a disk having an upper surface and a lower surface and perforating slots between the two surfaces. The upper surface of the insert 801 includes a series of spacers 802 that locate within recess in the cap 601 and separate the insert 801 a distance from the underside of the cap, such that when the insert 801 is fixed into the cap, a network of channels join the wash fluid inlet 204. The insert 801 has two concentric rings of slots; inner slots 803 and outer slots 804. These allow passage of the wash water from the channels into the chamber 201. The slots have guides around their periphery to guide wash water towards the meshes. The insert 801 further has a first channel 805 for receiving the first mesh structure 608 and a recess 806 for receiving the second mesh structure 614.

In use, when a wash cycle is complete and the drain pump drains the drum of the washing machine, effluent enters the inlet 604 and then is fed tangentially into the chamber 605, as shown in FIG. 9a. It then rotates within the chamber, throwing larger debris out to the side, which sinks down into the first sump 612. The effluent then turns sharply under the vortex finder 606, ejecting further debris under inertial action as it does so, which sinks into the first sump 612. The effluent then reaches the first mesh 608 which prevents debris and microfibers of size greater than 400 um passing, which either stick to the outside of the mesh or sink down into the first sump 612. The effluent then reaches the second mesh which prevents microfibers of size greater than 50 um from passing. These either adhere to the outside of the mesh or sink down to second sump 617. When the drum is drained, no more effluent flows into the separator and the liquid level inside the chamber 605 drops, so that only the sumps remain with liquid in them. As the liquid level falls, a certain amount of debris will fall off the meshes and into the sumps.

When the CPU finishes the wash cycle finishes and the drum is drained, the CPU activates the wash fluid inlet valve 405 and the mesh is rinsed with clean mains water. Debris is washed from the outside of the mesh and sinks to the bottom of the chamber, past the ring baffles 209, 210 into the sump.

Eventually the sumps will become full and will need to be emptied. This is performed by removing the end cup 603 as shown in FIG. 8b. The flange 611 and first mesh support structure 607 can then be removed exposing the first sump 612 for emptying and cleaning. The process is reversed for reassembly.

The separator may be “de-tuned” to a lower efficiency, for example 95% efficient at removing microfibers of length greater than 25 um, which would decrease the load on the washing machine pump. This could be achieved by using coarser meshes or by increasing the gap between the vortex finder and the upper ring baffle.

The separator may have only a single mesh structure or alternatively three or more mesh structures may be provided. The sumps may be located at a greater distance from the chamber and connected by pipes.

A water purification element may be added to further filter the wastewater so that all impurities are removed and render it drinkable. Such an element could be the inclusion of activated charcoal within the second mesh structure. The second mesh structure could be filled with activated charcoal or a further coaxial cylindrical element could be provided within the second mesh structure and the cavity between these two structures filled with activated carbon. A secondary pump may be required to provide enough pressure to the wastewater to urge it through this additional stage.

The separator may further include a bypass duct. The bypass duct may include a valve-operated system for diverting the flow of effluent around the chamber, operated by a sensor. If the fluid pressure at the inlet is detected by the sensor to rise above a safe working threshold, this indicates a problem with the separator such as a blockage that could result in a leak. The CPU can then operate the bypass valve to divert the flow of effluent around the separator. Alternatively, the bypass duct could include a passive valve arranged to open when the pressure reaches a threshold value.

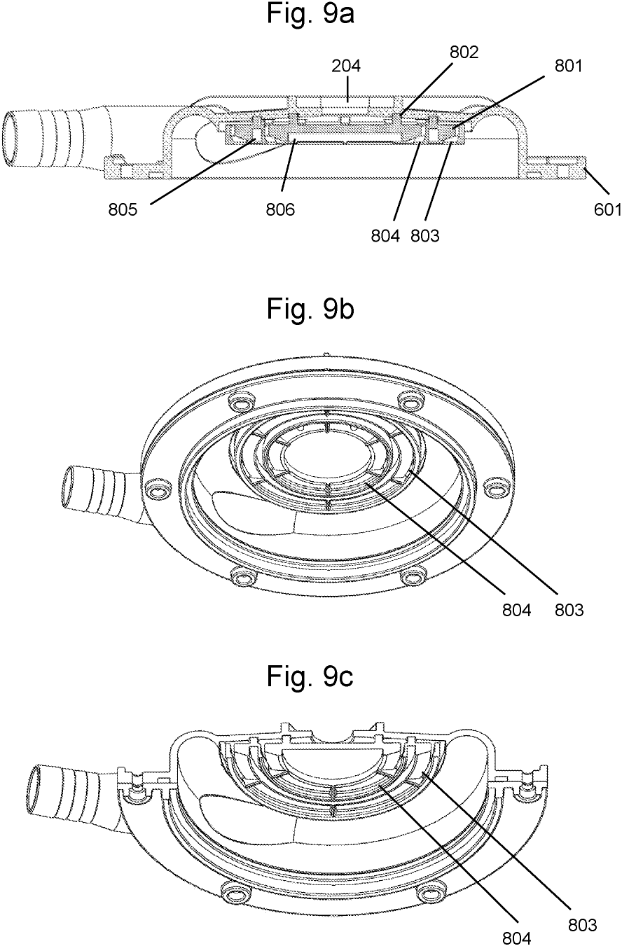

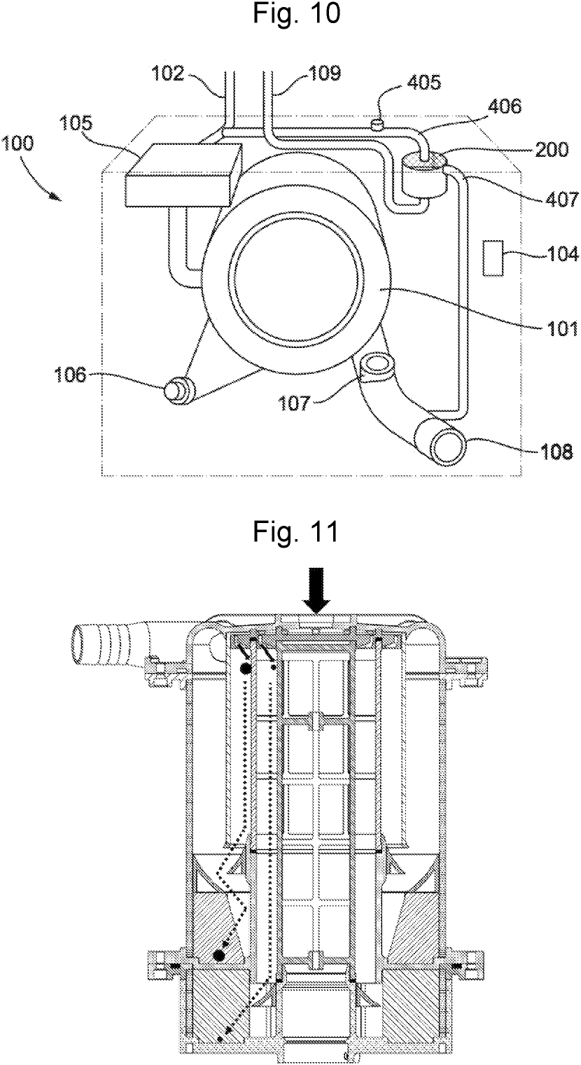

FIG. 10 is a view of an embodiment of the invention installed in a washing machine, while FIG. 11 is a view of the flow path of wash water.

The embodiment described above is suitable for installation in a domestic washing machine. However, the separator can be mounted externally to a washing machine so that it can be retrofitted. In this embodiment, the waste outlet of the washing machine is attached to the inlet of the separator 600 and its outlet attached to the waste pipe.

Wastewater expelled from textile factories is contaminated with microfibres and it is not guaranteed it will be filtered at municipal facilities. When these facilities exist, they may remove up to 98% of microplastics, however what escapes still equates to millions of microfibres every day. Microfibres removed from water may then be passed to the environment as “sewage sludge”, spread on agricultural land as fertiliser. Ultimately microfibres are passed as pollutants into the natural environment - they need to be stopped at source.

Wet-processing factories currently operate in a linear system, whereby microfibre resources are expelled as pollutants from the technical process into the biological environment. Use of the separator system described herein closes the loop into a continued cycle to retain the value of the microfibres within the technical process and stop damage to the biological environment.

An embodiment of the separator system can be retrofitted onto the existing wastewater outlet of wet-processing textile factories to enable microfibre capture at source before pollution of the natural environment can occur.

The separator system can be used to filter microplastics and other micropollutants from environmental drainage systems, such as roadside gullies. A lot of microplastics in the environment break down from larger items of plastic such as car tyres, road surfaces and road markings. After synthetic textiles, tyres are the largest source of microplastics and contain harmful materials such as mineral oils.

Catalytic converters are fitted on most cars and contain highly valuable materials such as platinum, palladium, copper and zinc. During use, small amounts of these metals are lost from cars and fragments are deposited on the road surface. While metal concentrations vary geographically, collection and recycling of these materials not only reduces environmental pollution but can also be a revenue stream in a circular economy.

Typical sewage networks are built along one of two designs:
i) Combined sewers. These collect surface water and sewage together, meaning all waste water passes through a Wastewater Treatment Plant (WWTP). During heavy rainfall, it is common for sewers to overflow, releasing untreated sewage and pollution into waterbodies.
ii) Separate sewers. These discharge surface water directly into waterbodies.

In both systems, roadside runoff, i.e. surface water from the roads, is released into the environment.

Most roadside gullies have drains located at regular points and these drains have a sediment “pot”, which lets heavy materials like gravel and sand settle to prevent blockage. These hold some micropollutants, but the majority of microplastics and valuable metals are too small and are not retained.

An embodiment of the separation system of the present invention can be retrofitted as an insert into the sediment pot of a drain to filter micropollutants at source. It is designed to fit existing gullies and to be emptied using a mobile vacuum pump.

The disclosure in the abstract is incorporated herein by reference.

1. A separator suitable for separating microplastics from effluent comprising;
a chamber having an inlet conduit and an outlet conduit wherein an internal portion of the chamber is circular in cross-section and wherein the inlet conduit is connected tangentially to the circular portion of the chamber,
the chamber further including a vortex finder comprising a shroud having a circular cross-section portion extending down into the chamber,
the separator further including at least one sieve structure downstream from the shroud and arranged to provide a permeable barrier between the inlet conduit and the outlet conduit, wherein the chamber further includes a baffle that is coaxial with the shroud and projecting upwards from the lower end of the chamber, wherein the shroud has a circular lower rim and the baffle has a circular upper rim, wherein the radius of the lower rim of the shroud is greater than the radius of the upper rim of the baffle.

2. The separator of claim 1, wherein
a first sieve structure and a second sieve structure are provided, wherein the second sieve structure is included downstream from the first sieve structure, providing a permeable barrier between the inlet conduit and the outlet conduit, wherein the second sieve has a smaller opening size than the first sieve structure.

3. The separator of claim 1 or claim 2, wherein the outlet is at the lower end of the chamber.

4. The separator of claim 2 or claim 3 when dependent on claim 2, wherein the shroud, the first sieve structure and the second sieve structure are cylindrical and coaxially aligned.

5. The separator of claim 1 or claim 2, wherein the outlet is at the upper end of the chamber.

6. The separator of claim 5, wherein the shroud is frustoconical.

7. The separator of claim 6 when dependent on claim 5 dependent on claim 2, wherein the first sieve structure and the second sieve structure are conical and coaxial with the shroud.

8. The separator of claims 2 to 7, wherein the sieve structures comprise a mesh.

9. The separator of claim 8, wherein the mesh size of the first sieve structure is in the range 20 um to 1 cm.

10. The separator of claim 9, wherein the mesh size of the first sieve structure is in the range 200-500 um.

11. The separator of claim 8, wherein the mesh size of the second sieve structure is in the range 20-200 um.

12. The separator of claim 11, wherein the mesh size of the second sieve structure is in the range 40-90 um.

13. The separator of any preceding claim, wherein the chamber has an upper turbulent region and a lower static region separated by at least one baffle.

14. The separator of claim 13, including a pair of opposing offset ring baffles to separate the turbulent region from the static region.

15. The separator of claim 13 or 14, wherein fins are provided in the static region for slowing the radial flow of effluent.

16. The separator of any one of claims 13 to 15 when dependent on claims 2 to 12, wherein a first sump is provided below the first sieve structure in the static region and a second sump is provided below the second sieve in the static region, wherein the first and second sumps are isolated from each other by the first sieve structure.

17. The separator of claim 16 comprising a removable lid and plug assembly for emptying the sumps.

18. The separator of claim 16 or 17, wherein the lower end of the separator is removable for emptying the sumps.

19. The separator of any preceding claim, comprising a sensor for detecting fluid pressure at the inlet.

20. The separator of claim 19, wherein the sensor is arranged to communicate with a warning system, such that, in use, if the fluid pressure measured by the sensor rises above a first threshold, issuing a warning that the separator needs cleaning.

21. The separator of claim 20, further including a bypass duct between the inlet and the outlet, wherein the bypass duct is engaged by operation of a bypass valve.

22. The separator of claim 21, wherein the sensor is arranged to operate the bypass valve if, in use, the fluid pressure measured by the sensor rises above a second threshold, indicating that there is a blockage in the chamber of the separator.

23. The separator of claim 21, wherein the bypass valve is passive and is arranged to open when the pressure reaches a threshold value.

24. The separator of any preceding claim, further including a wash apparatus for washing the at least one sieve structure.

25. The separator of claim 23, wherein the wash apparatus includes at least one channel terminating in a cavity for guiding wash fluid to spray the exterior of the at least one sieve structure.

25. The separator of any preceding claim, wherein the separator includes a wash fluid valve for controlling the flow of wash fluid into the inlet.

26. The separator of claim 25, wherein the sensor is arranged to detect when the flow of effluent has ceased and send a signal capable of opening the wash fluid valve.

27. The separator of any preceding claim, wherein a water purification element is included to further filter the effluent.

28. The separator of claim 27, wherein the water purification element includes activated charcoal within the sieve structure.

29. The separator of claim 28 when dependent on claims 2 to 27, wherein the second mesh structure includes a coaxial wall within the second mesh structure and the cavity between these two structures is filled with activated carbon.

30. The separator of claim 29, wherein a secondary pump is included to urge the effluent through the water purification element.

31. A processing appliance including a separator of the type claimed in claims 1 to 30.

32. The processing appliance of claim 31, wherein the processing appliance is a washing machine.

33. The processing appliance of claim 31, wherein the appliance comprises industrial textile manufacturing equipment.

34. A separator of the type claimed in claims 1 to 30 for use in a drainage system.

35. A drain including a separator of the type claimed in claims 1 to 30.

36. A method of operating a separator of the type claimed in claims 1 to 30, comprising the steps of:
receiving a flow of effluent;
passing the effluent through a cyclonic separation stage;
passing the effluent through a first sieve stage;
passing the effluent through a second sieve stage, where the second sieve pore size is less than the pore size of the first sieve stage;
collecting the debris separated from the effluent by the cyclonic separation and first and second sieve stages.

37. The method of claim 34, wherein the wastewater is wastewater from a washing machine.

38. The method of claim 34, wherein the wastewater is wastewater from industrial textile manufacturing equipment.

39. The method of claim 34, wherein the wastewater is wastewater from a roadside drain.
